(19) United States
(12) Patent Application Publication
(10) Pub. No.: US 2024/0176675 A1
(43) Pub. Date: May 30, 2024

(54) SYSTEMS AND METHODS FOR EFFICIENT PROCESSING OF DATA ASSOCIATED WITH SYSTEM RESOURCES

(71) Applicant: Optum Services (Ireland) Limited, Dublin (IE)

(72) Inventors: Taleen AVAKIAN-FEENEY, Wicklow (IE); Sharyn FARRELLY, Milford (IE); James C. VON HOLTEN, Galena, OH (US); Crystal Alanna REED, Johnstown, PA (US); Carla Fulford BURNS, Big Pine Key, FL (US)

(21) Appl. No.: 18/501,189

(22) Filed: Nov. 3, 2023

Related U.S. Application Data
(60) Provisional application No. 63/385,124, filed on Nov. 28, 2022.

(51) Int. Cl. G06F 9/50

(52) U.S. Cl. CPC G06F 9/5083

(57) ABSTRACT

Systems and methods are disclosed for determining a buffering period based on historical latency in data communication. The method includes a first computing system receiving a first set of data. The first computing system determines a buffering period based at least in part on historical latency in communicating data between the first computing system and a second computing system. The first computing system queues the first set of data with the buffering period for delayed processing of the first set of data. The first computing system receives from the second computing system a second set of data prior to the expiration of the buffering period. The first computing system initiates the processing of the first set of data in view of the second set of data.

### CROSS-REFERENCE TO RELATED APPLICATION(S)

This patent application claims the benefit of priority to U.S. Provisional Application No. 63/385, 124 filed on Nov. 28, 2022, the entirety of which is incorporated herein by reference.

### TECHNICAL FIELD

This present disclosure relates generally to the field of data processing. In particular, the present disclosure relates to data analysis for providing information associated with communication latency.

### BACKGROUND

Computer networks are designed to optimize efficient network communication between disparate systems. However, latency in communicating data can influence the efficiency of data-dependent systems. For example, high latency indicates reduced data transfer speed from the source system to the destination system, thereby slowing down the response time of the destination system. Such communication latencies can cause a substantial disconnect between data, resulting in the destination system processing data with missing information that it did not yet receive from the source system. Processing missing data can produce biased estimates, leading to invalid conclusions (e.g., false or misleading results). Hence, there is a need for a method for handling the latency in communicating data and the missingness of the data during data analysis.

### SUMMARY OF THE DISCLOSURE

The present disclosure solves the problems of latency in communicating between disparate systems and improves the state of conventional technologies by generating an artificial buffering period by utilizing historical latency in communicating data between disparate systems.

Conventional data processing systems fail to efficiently capture and report data (e.g., medical data or any relevant data) required for determining primacy timelines for various resources (e.g., healthcare services or any other services). Typical data processing technologies have limited capabilities in scaling down enormous volumes of data for focused analytics processing to provide real-time data surveillance for generating predictions. The known systems have limited technological capabilities to perform targeted data processing for offering dynamic notification capabilities. Accordingly, there is a need for a system that processes real-time and historical data for predicting delays in data updates, utilizes the predicted delays for determining a buffering period for primacy timelines, and monitors, in real-time, updates from disparate systems for accurate processing of the claims related to various services.

In some embodiments, a computer-implemented method includes: receiving, by one or more processors of a first computing system, a first set of data; determining, by the one or more processors, a buffering period based at least in part on historical latency in communicating data between the first computing system and a second computing system; queuing, by the one or more processors, the first set of data with the buffering period for delayed processing of the first set of data; receiving, by the one or more processors and from the second computing system, a second set of data prior to expiration of the buffering period; and initiating, by the one or more processors, processing of the first set of data in view of the second set of data.

In some embodiments, a system includes one or more processors of a first computing system; and at least one non-transitory computer readable medium storing instructions which, when executed by the one or more processors, cause the one or more processors to perform operations including: receiving a first set of data; determining a buffering period based at least in part on historical latency in communicating data between the first computing system and a second computing system; queuing the first set of data with the buffering period for delayed processing of the first set of data; receiving, from the second computing system, a second set of data prior to expiration of the buffering period; and initiating processing of the first set of data in view of the second set of data.

In some embodiments, a non-transitory computer readable medium, the non-transitory computer readable medium storing instructions which, when executed by one or more processors of a first computing system, cause the one or more processors to perform operations including: receiving a first set of data; determining a buffering period based at least in part on historical latency in communicating data between the first computing system and a second computing system; queuing the first set of data with the buffering period for delayed processing of the first set of data; receiving, from the second computing system, a second set of data prior to expiration of the buffering period; and initiating processing of the first set of data in view of the second set of data.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system for determining a buffering period based on historical latency in data communication between disparate systems, according to aspects of the disclosure.

FIG. 2 is a flowchart of a process implemented by the system of FIG. 1 for determining the buffering period based on historical latency in data communication, according to aspects of the disclosure.

FIGS. 3A-C are diagrams that represent an active period, a coordination period, and a buffering period for a resource, according to aspects of the disclosure.

FIG. 4 is a flow diagram that illustrates a process for determining primacy between payer entities during varying time periods of a resource, according to aspect of the disclosure.

FIG. 5 is a flow diagram that illustrates a process for data updates and review while generating a buffering period, according to aspect of the disclosure.

FIG. 6 is a flow diagram that illustrates a process for automated updates of the timeline for a resource, according to aspect of the disclosure.

FIG. 7 is a diagram that illustrates a timeline graph for a resource, according to aspect of the disclosure.

FIG. 8 is a user interface diagram that displays relevant information associated with a resource, according to aspect of the disclosure.

FIG. 9 shows an example machine learning training flow chart.

FIG. 10 illustrates an implementation of a computer system that executes techniques presented herein.

### DETAILED DESCRIPTION OF EMBODIMENTS

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the present disclosure is not to be considered as limited by the foregoing description.

Various non-limiting embodiments of the present disclosure will now be described to provide an overall understanding of the principles of the structure, function, and use of systems and methods disclosed herein for generating buffering period utilizing historical latency in communicating data between disparate systems.

The service providers (e.g., healthcare service providers) are technically challenged by the slow-moving infrastructure that suffers from various claim adjudication problems. There are multiple rules scattered all over multiple resources that dictate who is the primary payer entity and when they are primary based on the situation. In the absence of comprehensive knowledge of these rules, claims submitted to the payer entities (e.g., private medical insurance companies or public medical insurance companies administering private, federally-sponsored, and/or state-sponsored medical insurance programs that finance or reimburse the cost of health services) are often rejected. The claim rejections typically begin a long cycle of correction and resubmission, costing the healthcare service provider both time and money in trying to collect what is owed to them. In one example embodiment, user A elects a resource (e.g., Hospice service, palliative care service, etc.), and the term date for the resource in the healthcare system is till Nov. 30, 2022. The healthcare system then receives a delayed notification on Dec. 8, 2022, for extending the term date till Jan. 31, 2023. Since there has been a delay in the notification, the healthcare system adjudicates the previous payer entity (i.e., the payer entity adjudicated as primary till Nov. 30, 2022) as responsible for the claims between Dec. 1, 2022, and Dec. 8, 2022. Such latency in communication between disparate systems results in processing incomplete data, and indecisively or inaccurately adjudicating a primary payer entity.

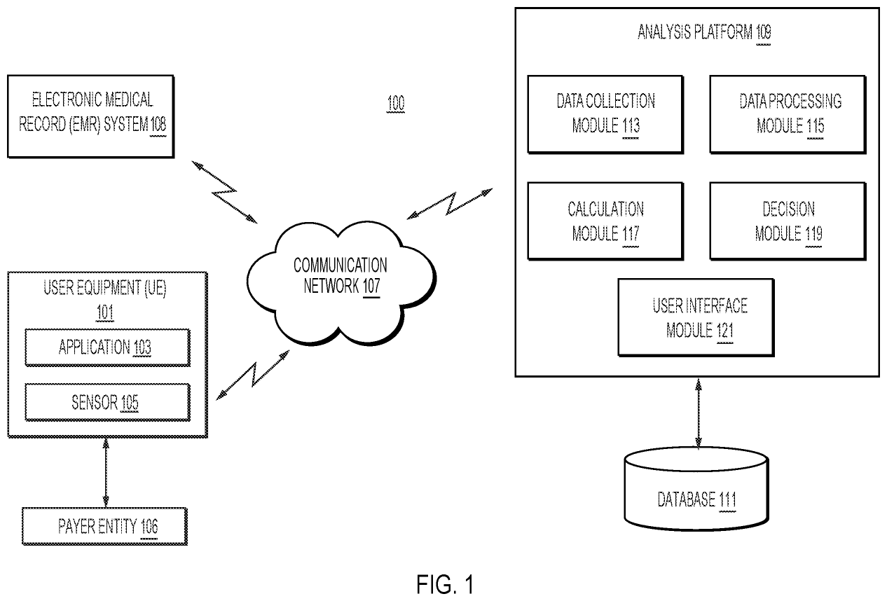

To address these technical challenges, system 100 of FIG. 1 implements advanced data processing and computing capabilities into the methods and systems for seamlessly providing primacy timelines, where the data is expected but not yet received, and the system 100 predicts a buffering period for primacy timelines awaiting late or missing data. In one embodiment, the system 100 factors average delays in updates by the healthcare service providing entities for resources (e.g., Hospice service, palliative care service, or any other type of services) by utilizing real-time and historical data (e.g., medical data or healthcare data). The steps implemented by the system 100 for generating buffering period utilizing historical latency in communicating data between disparate systems include: (i) identifying members (e.g., registered patients) in-scope for healthcare services (e.g., hospice services), (ii) calculating the days the members are covered by the active period (e.g., hospice benefit period), (iii) determining a ‘primary’ payer entity from the plurality of payer entities, (iv) calculating the amount of time it takes to receive notification (e.g., enrollment notification) for the healthcare services after an initial election, (v) calculating the amount of time a coordination period (e.g., hospice coordination period) can be extended (e.g., hospice buffering period) in advance of a notification, and (vi) generating an output that differentiates between the benefit period, the coordination period, and the buffering period to enable accurate claim processing for all value streams involved.

As discussed, existing approaches for latency detection and control during data communication do not provide for desirable solutions. System 100 provides technical advantages over the limited capabilities of the conventional systems by efficiently processing data (e.g., real-time data and historical data) for focused analytics, predicting delays in communication between disparate systems, utilizing the predicted delays for determining a buffering period, and monitoring, in real-time, for updates for accurate processing of the claims during the buffering period. For example, system 100 characterizes latency in communication between disparate systems by one or more of: an average duration of data transfer between disparate systems, a minimum duration of data transfer between disparate systems, a maximum duration of data transfer between disparate systems, a variance of the duration of data transfer between disparate systems, and/or a probability that duration of data transfer between disparate systems exceeds a duration threshold. System 100 determines a buffering period based on the latency in communicating data, per the methods described herein, for receiving missing or delayed datasets to process complete datasets. Accordingly, system 100 provides technical advantages over conventional techniques by reducing disconnect between incomplete data, improving data quality, and yielding results with high accuracy.

FIG. 1 is an example architecture of one or more example embodiments of the present disclosure. System 100 that comprises user equipment (UE) 101a-101n (collectively referred to as UE 101) that includes applications 103a-103n (collectively referred to as an application 103) and sensors 105a-105n (collectively referred to as a sensor 105), payer entity 106, a communication network 107, electronic medical record (EMR) system 108, an analysis platform 109, and a database 111.

In one embodiment, the UE 101 includes, but is not restricted to, any type of mobile terminal, wireless terminal, fixed terminal, or portable terminal. Examples of the UE 101, include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 101 facilitates various input means for receiving and generating information, including, but not restricted to, a touch screen capability, a keyboard and keypad data entry, a voice-based input mechanism, and the like. The UE 101 is also configured with different features for generating, sharing, and viewing of visual content. Any known and future implementations of the UE 101 are also applicable. In one example embodiment, the payer entity 106 utilizes the UE 101 to perform various activities, for example, the payer entity 106 interacts with healthcare service providers (e.g., EMR system 108) for healthcare claims inquiries, billing-related inquiries, payment-related inquiries, reimbursement inquiries, portioning of an invoice to split the payment, distribution of payment per contracts with the patients or other payer entities, etc.

In one embodiment, the application 103 includes various applications such as, but not restricted to, content provisioning applications, software applications, notification services, networking applications, multimedia applications, media player applications, camera/imaging applications, application services, storage services, contextual information determination services, location-based services, social networking services, and the like. In one embodiment, one of the application 103 at the UE 101 acts as a client for the analysis platform 109 and performs one or more functions associated with the functions of the analysis platform 109 by interacting with the analysis platform 109 over the communication network 107.

By way of example, each sensor 105 includes any type of sensor. In one embodiment, the sensors 105 include, for example, a network detection sensor for detecting wireless signals or receivers for different short-range communications (e.g., Bluetooth, Wi-Fi, Li-Fi, near field communication (NFC), etc. from the communication network 107), a global positioning sensor for gathering location data (e.g., location associated with the patients, the payer entity 106, the healthcare provider entities, etc.), a camera/imaging sensor for gathering image data (e.g., images of invoices from the healthcare provider entity), an audio recorder for gathering audio data (e.g., recordings of medical treatments, medical diagnosis, etc.), and the like.

In one embodiment, the payer entity 106 is responsible for making payments for the treatments administered to the patient (e.g., hospice care, palliative care, etc.). The payer entity 106 includes federal health insurance programs (e.g., Medicare), Federal-approved plans from private companies (e.g., Medicare advantage plans), and any other healthcare insurance providers. The analysis platform 109 selects at least one entity as ‘primary’ from the payer entity 106 based on the methods described herein.

In one embodiment, various elements of the system 100 communicate with each other through the communication network 107. The communication network 107 supports a variety of different communication protocols and communication techniques. In one embodiment, the communication network 107 allows the UE 101 to communicate with the analysis platform 109. The communication network 107 of the system 100 includes one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one embodiment, the EMR system 108 (e.g., a second computing system) is an automated system for capturing data (e.g., medical data) associated with the users (e.g., registered patients) from various databases (e.g., state government databases, federal government databases, public health institutions databases (e.g., Center for Medicare & Medicaid Services (CMS) database), etc.) to generate electronic records for transmission to participating entities (e.g., analysis platform 109). The EMR system 108 transforms a patient's medical chart from a static record into a dynamic, comprehensive record linked to various databases. In one instance, the electronic record includes patient information (e.g., name, address, phone number, date of birth, social security number, etc.), medical information (e.g., diagnosis, test results, prescribed medications, professional services provided, notes entered by the physician or other healthcare personnel, etc.), financial information (e.g., billing information, insurance information (e.g., hospice benefit period, palliative care timeline, etc.), payment information, transaction history, claims data, etc.), and any other relevant information (e.g., transaction reply report (TRR) transactions). In another embodiment, the EMR system 108 collects images of medical records uploaded by the users (e.g., patients, physicians, medical staff, etc.) via application 103 of the UE 101. The EMR system 108 then extracts textual data from the images of medical records. The extracted textual data is in a rich text, HTML text, or any other text which retains the format and location of the data as it appeared in the images of medical records.

In one embodiment, the analysis platform 109 is a platform with multiple interconnected components. The analysis platform 109 includes one or more servers, intelligent networking devices, computing devices, components, and corresponding software for determining a buffering period based on historical latency in data communication between disparate systems. In one instance, to enable automation, generate seamless primacy timelines, and reduce rework due to late or missing data, the analysis platform 109 (e.g., a first computing system) generates a buffering period for awaiting expected data that is not yet received from the EMR system 108. In one example embodiment, the analysis platform 109 calculates average delays in reporting timeline data to generate a buffering period for processing claims (e.g., hospice claims) while waiting on new information. If expected data is received within the calculated buffering period, there is no impact on claims processing. Whereas, if the expected data is not received within the calculated buffering period, the timeline is re-calculated with the data that exists and will persist until new data is received.

In one embodiment, the analysis platform 109 comprises a data collection module 113, a data processing module 115, a calculation module 117, a decision module 119, a user interface module 121, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one example embodiment, patients, especially those with chronic illnesses, engage with a variety of healthcare professionals during their diagnosis and treatments. When multiple entities (e.g., payer entities 106) are responsible for payment of a patient's treatments (e.g., hospice care, palliative care, etc.), an indicator (e.g., a flag) is attached to the patient's medical record for accurate claim payment. However, the patient's treatment information spread across these multiple entities can lead to incomplete or missing medical data among them, thereby adversely affecting payments for the treatments. The disconnect between various information sources relied upon and the lack of collaboration when using a conventional system result in sub-optimal healthcare for the patient. Such uncoordinated handling of medical data detrimentally affects the patient's overall treatment and results in inefficiencies. The conventional solutions do not account for the inherent latency in communications between disparate systems that results in the processing of incomplete data. For example, primacy timelines for healthcare services (e.g., hospice care, palliative care, etc.) are calculated using incremental dates as the claims are submitted. These primacy timelines can be delayed by upwards of 35 days. Such delays impede instantaneous notification, thus causing conventional claim platforms to loop through payment and recovery cycles. This is because the primacy timeline for hospice indicating another payer entity is ‘primary’ was typically adjusted after-the-fact (e.g., initial elections are set after-the-fact, term dates are extended after-the-fact, and term dates are back-dated after-the-fact). Such frequent after-the-fact adjustments to primacy timelines cause net promoter score (NPS) abrasions for the providers and terminally ill patients often cannot reconcile their payments without assistance.

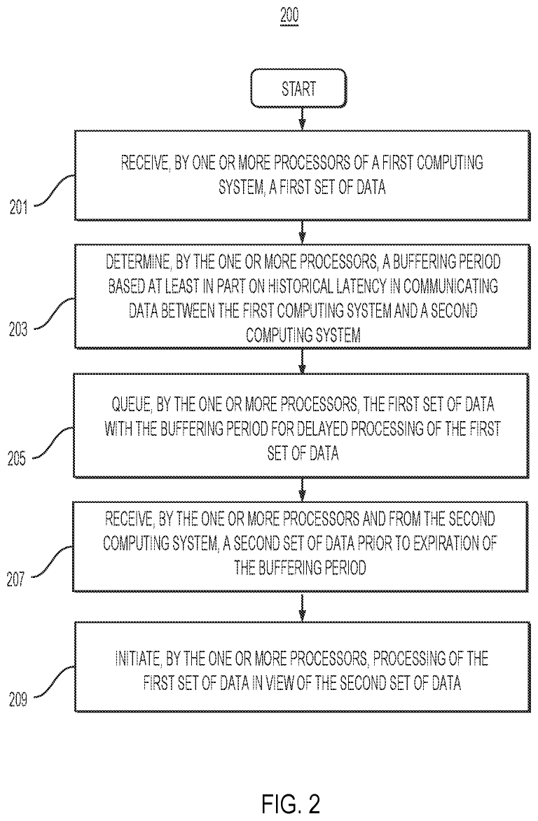

To address these technical challenges, the analysis platform 109 analyzes medical data through an automated, sophisticated computing intelligence, enabling accurate predictions of parameters for guiding payer entities involved with the treatment of patients. The analysis platform 109 generates an artificial buffering period that is developed using historical latency data between disparate systems. In one embodiment, the analysis platform 109 receives the first set of data. The analysis platform 109 determines a buffering period based on historical latency in communicating data between the first computing system and the second computing system. The analysis platform 109 queues the first set of data with the buffering period for delayed processing of the first set of data. The analysis platform 109 receives, from the second computing system, a second set of data before the expiration of the buffering period. The analysis platform 109 initiates the processing of the first set of data in view of the second set of data. These steps are discussed in the description for FIG. 2.

In one embodiment, the data collection module 113 collects, in real-time or near real-time, relevant data (e.g., patient information, medical information, financial information, etc.) associated with the users (e.g., registered patients) through various data collection techniques. In one embodiment, the data collection module 113 uses a web-crawling component to access the EMR system 108 or other information sources to collect relevant data. In one example embodiment, the data collection module 113 accesses plan communication user guide (PCUG) technical guidance from database 111 and TRR transactions from EMR system 108. In another example embodiment, the data collection module 113 accesses Medicare claim processing technical guidance from database 111. In one embodiment, the data collection module 113 includes various software applications, e.g., data mining applications in Extended Meta Language (XML), that automatically search for and return relevant data regarding the users. In another embodiment, the data collection module 113 collects images of medical records uploaded by the users via the user interface of UE 101.

In one embodiment, the data collection module 113 transmits the collected data to the data processing module 115 for data standardization and/or data cleansing. In one embodiment, data standardization includes standardizing and unifying data. The data processing module 115 converts the collected data into a common format (e.g., machine readable form), that is easily processed by other modules and platforms. In one embodiment, the data cleansing technique detects and corrects inconsistencies originally caused by user entry errors, corruption during transmission or storage, or by utilization of different definitions for similar data. The data cleansing technique includes removing or correcting erroneous data (e.g., typographical errors) or validating and correcting values against a known list of entities. The data cleansing technique also includes cleaning data by cross-checking the data with a validated data set, standardizing the data by changing a reference data set to a new standard, e.g., use of standard codes, and/or the like. Additionally, the data cleansing technique includes data enhancement, where data is made more complete by adding related information.

In one embodiment, the calculation module 117 receives the processed data from the data processing module 115, and is configured to perform calculations on the processed data utilizing various computing algorithms for data analysis and interpretation. In one embodiment, the calculation module 117 utilizes the sum of TRR data and claims data to calculate the days a user is covered by the resource (e.g., benefit period for a healthcare service). In one embodiment, the calculation module 117 utilizes historic TRR data and claims data to calculate the amount of time it takes for the first computing system (e.g., analysis platform 109) to receive a notification (e.g., enrollment notification for a healthcare service after an initial election or a re-election) from the second computing system (e.g., EMR system 108). In one embodiment, the calculation module 117 utilizes the average delayed notification time to calculate the amount of time a coordination period for the resource (e.g., hospice coordination period) can be extended in advance of the notification by adding a buffering period (e.g., hospice buffering period) to the primacy term date. In such manner, the calculation module 117 calculates, expands, or condenses timelines for each in-scope member.

In one embodiment, the decision module 119 applies PCUG technical guidance in regard to the TRR transactions to identify one or more users (e.g., patients) in-scope for a resource (e.g., hospice service, healthcare services, etc.) for service coordination between the first computing system and the second computing system. The decision module 119 also applies Medicare claim processing technical guidance to Medicare advantage plans claims to identify users in-scope for the resource for service coordination between the first computing system and the second computing system. In another embodiment, the decision module 119 applies a plurality of logic (e.g., Medicare managed care logic in conjunction with value-based insurance design (VBID) model logic) to determine primacy between one or more payer sub-systems (e.g., payer entity 106). In a further embodiment, the decision module 119 determines the buffering period based on historical latency in communicating data between the first computing system and the second computing system.

In one embodiment, the user interface module 121 employs various application programming interfaces (APIs) or other function calls corresponding to the application 103 on the UE 101, thus enabling the display of graphics primitives such as icons, bar graphs, menus, buttons, data entry fields, etc. In one example embodiment, the user interface module 121 enables a presentation of a graphical user interface (GUI) in the UE 101 that facilitates visualization of medical records (e.g., a display that differentiates between the active period, the coordination period, and the buffering period associated with a service) for accurate claim processing. In another embodiment, the user interface module 121 causes interfacing of guidance information to include, at least in part, one or more annotations, audio messages, video messages, or a combination thereof pertaining to the information in the medical records. In one embodiment, the user interface module 121 comprises a variety of interfaces, for example, interfaces for data input and output devices, referred to as I/O devices, storage devices, and the like. Still further, the user interface module 121 is configured to operate in connection with augmented reality (AR) processing techniques, wherein various applications, graphic elements, and features interact.

The above presented modules and components of the analysis platform 109 are implemented in hardware, firmware, software, or a combination thereof. Though depicted as a separate entity in FIG. 1, it is contemplated that the analysis platform 109 is also implemented for direct operation by the respective UE 101. As such, the analysis platform 109 generates direct signal inputs by way of the operating system of the UE 101. In another embodiment, one or more of the modules 113-121 are implemented for operation by the respective UEs, as the analysis platform 109. The various executions presented herein contemplate any and all arrangements and models.

In one embodiment, the database 111 is any type of database, such as relational, hierarchical, object-oriented, and/or the like, wherein data are organized in any suitable manner, including data tables or lookup tables. In one embodiment, the database 111 accesses or stores content associated with the users, the UE 101, the payer entity 106, and the analysis platform 109, and manages multiple types of information that provide means for aiding in the content provisioning and sharing process. In one instance, the database 111 stores various information related to the users (e.g., medical records, claims data, invoice data, current procedural terminology (CPT) treatment codes for the medical treatment provided and/or the ICD9 diagnostic codes, medical history, personal information, etc.), the payer entity 106, (e.g., payer identification code, payer data, etc.), and guidelines (e.g., PCUG technical guidance, plan communication guide, Medicare claim processing technical guidance, Medicare benefit policy manual, Medicare claim processing manual, Medicare managed care manual. etc.). It is understood that any other suitable data may be included in the database 111. In another embodiment, the database 111 includes a machine-learning based training database with a pre-defined mapping defining a relationship between various input parameters and output parameters based on various statistical methods. For example, the training database includes machine-learning algorithms to learn mappings between input parameters related to the users and the payer entity 106. In one example embodiment, the training database includes a dataset that includes data collections that are not subject-specific, e.g., data collections based on population-wide observations, local, regional or super-regional observations, and the like. The training database is routinely updated and/or supplemented based on machine learning methods.

By way of example, the UE 101, EMR system 108, the analysis platform 109, and the database 111 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

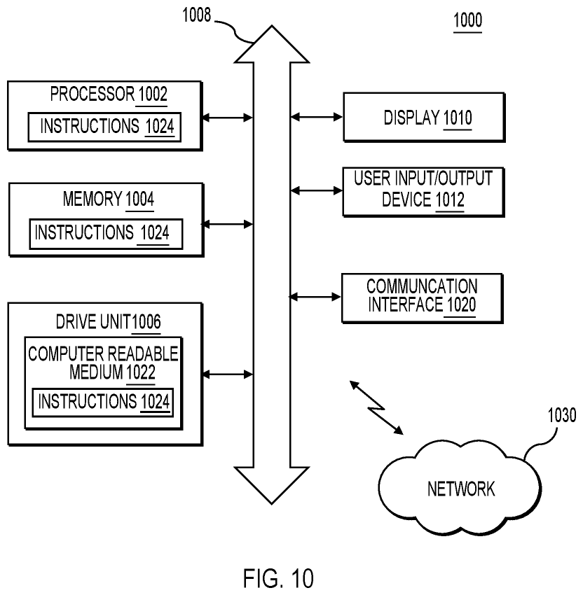

FIG. 2 is a flowchart of a process for determining a buffering period based on historical latency in data communication between the disparate systems, according to aspects of the disclosure. In various embodiments, the analysis platform 109 and/or any of the modules 113-121 performs one or more portions of the process 200 and are implemented using, for instance, a chip set including a processor and a memory as shown in FIG. 10. As such, the analysis platform 109 and/or any of modules 113-121 provide means for accomplishing various parts of the process 200, as well as means for accomplishing embodiments of other processes described herein in conjunction with other components of the system 100. Although the process 200 is illustrated and described as a sequence of steps, it is contemplated that various embodiments of the process 200 are performed in any order or combination and need not include all of the illustrated steps.

In step 201, the analysis platform 109, via processor 1002 of a first computing system, receives a first set of data. In one instance, the first set of data includes patient information, medical information, financial information, frequency of data communication between a first computing system and a second computing system, and any other relevant information. In one embodiment, the analysis platform 109, via processor 1002, queries one or more databases (e.g., EMR system 108, database 111) for data associated with one or more users (e.g., registered patients) and historical communication data between the first computing system and the second computing system. In one instance, the one or more databases are queried upon determining the data associated with the registered users is not received from the second computing system within a pre-determined time period. In one instance, the querying of the one or more databases includes extracting the data associated with the one or more users and the historical communication data between the first computing system and the second computing system.

In step 203, the analysis platform 109, via processor 1002, determines a buffering period based at least in part on historical latency in communicating data between the first computing system and the second computing system. In one instance, the historical latency includes a delay in communicating notifications pertaining to one or more users registered with the resource. For example, notifications include various data pertaining to a user (e.g., an active period the user is covered by the resource (e.g., a hospice service), payer entity data (e.g., primary payer information), healthcare data (e.g., treatments received by the user at a healthcare facility, total cost of the service), or any other relevant information). The buffering period for the resource remains modifiable until a true notification revokes the buffering period or an occurrence of a true break in coverage by the resource. In one embodiment, the analysis platform 109 processes the data associated with one or more users to determine an active period for the resource and a coordination period for the resource. In one instance, the active period is a duration the one or more users are covered by the resource. In one instance, the coordination period identifies primacy between a first payer sub-system and a second payer sub-system. In one instance, the data associated with one or more users includes transaction reply reports and/or claims data.

In one embodiment, the analysis platform 109 applies one or more rules to the data associated with the one or more users to identify at least one of the one or more users that is within coverage during the coordination period for the resource, wherein the buffering period is determined for the identified at least one user. In one embodiment, the analysis platform 109 processes historical communication data between the first computing system and the second computing system to predict a duration for receiving a notification (e.g., enrollment notification) pertaining to one or more users registered with the resource. The analysis platform 109 calculates an average delay in transmitting the notification by the second computing system to the first computing system. In one embodiment, the analysis platform 109 extends the coordination period for the resource by a time period equivalent to the average delay in transmitting the notification by the second computing system to the first computing system.

In step 205, the analysis platform 109, via processor 1002, queues the first set of data with the buffering period for delayed processing of the first set of data. In one embodiment, the analysis platform 109 monitors one or more databases for the second set of data and the expiration of the buffering period. The analysis platform 109 updates the buffering period based on the monitoring. For example, the analysis platform 109 recalculates the buffering period upon determining the enrollment notification is not received within the predicted buffering period for the resource.

In step 207, the analysis platform 109, via processor 1002 and from the second computing system, receives a second set of data prior to the expiration of the buffering period. In one instance, the second set of data includes data pertaining to active periods (e.g., benefit periods) for the resource or any other relevant data that completes the first set of data.

In step 209, the analysis platform 109, via processor 1002, initiates the processing of the first set of data in view of the second set of data. In one instance, the analysis platform 109 applies one or more logics to determine primacy between one or more payer sub-systems during at least one of the active period, the coordination period, or the buffering period. In one instance, the active period represents a first time period the resource is covered by the first payer sub-system (e.g., at least one of the payer entities 106). In one instance, the coordination period represents a second time period the resource is covered by the first payer sub-system or the second payer sub-system (e.g., at least one of the other payer entity 106). In one instance, the buffering period represents a third time period the resource is covered by the first payer sub-system in anticipation of the enrollment notification. The analysis platform 109 displays a presentation of the active period, the coordination period, or the buffering period in a user interface of a device.

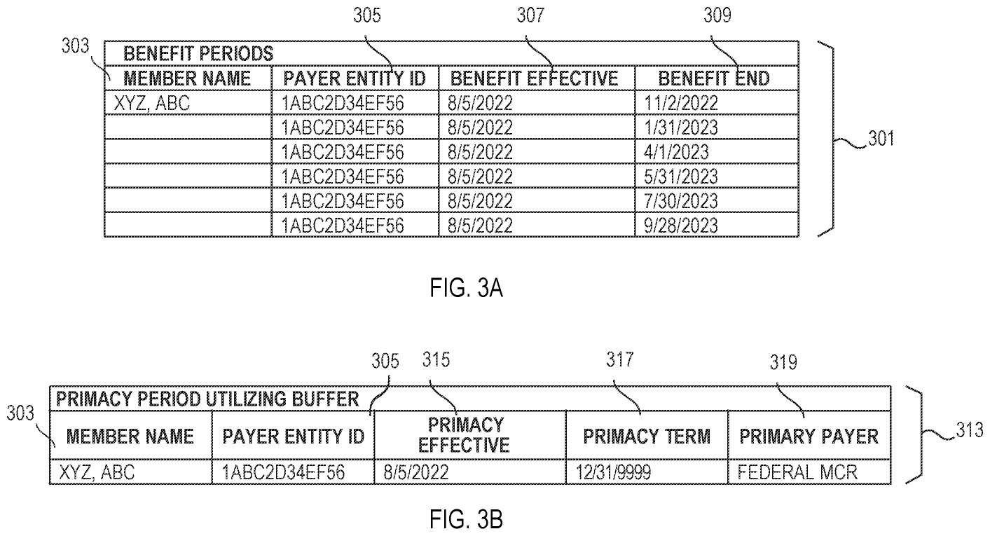

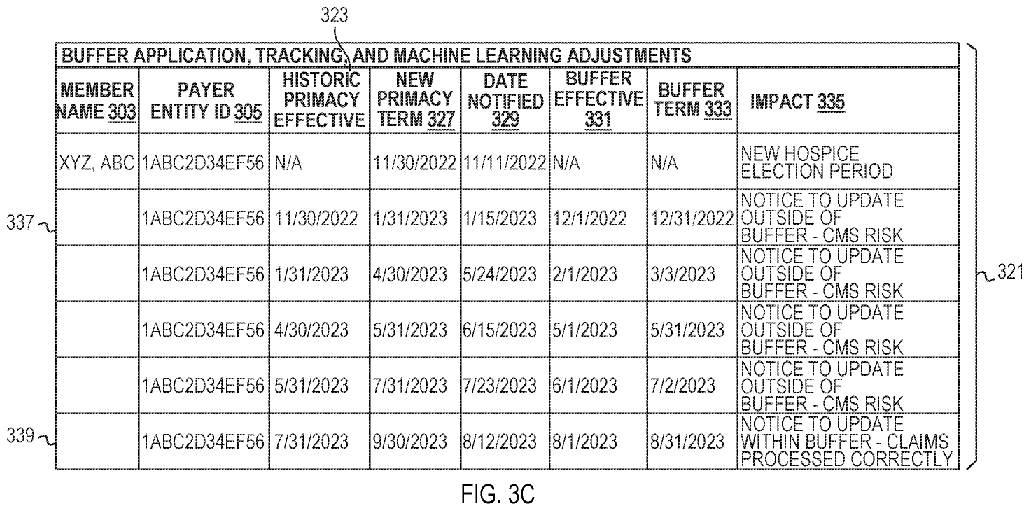

FIGS. 3A-C are diagrams that represent an active period, a coordination period, and a buffering period for a resource (e.g., health-care related services), according to aspects of the disclosure. In one example embodiment, table 301 of FIG. 3A indicates the benefit period. Table 301 includes member name 303, payer entity ID 305, benefit effective 307, and benefit end 309. The benefit effective 307 and benefit end 309 of table 301 indicate the active period for the resource (e.g., a benefit period for hospice services) where the resources are payable by the first payer entity 106 (e.g., Federal Medicare system). As illustrated, user ABC has active periods in-between Aug. 5, 2022, and Sep. 28, 2023. However, there is a delay in communicating the active periods (e.g., latency in communicating data between the first and second computing systems) in-between Aug. 5, 2022, and Sep. 28, 2023. Such latency in communication between disparate computing systems results in the processing of incomplete data that results in delayed and erroneous outcomes.

In one example embodiment, analysis platform 109 generates table 313 of FIG. 3B that indicates a primacy period utilizing buffer. Table 313 includes member name 303, payer entity ID 305, primacy effective 315, primacy term 317, and primary payer 319. The primacy effective 315 and primacy term 317 indicate the coordination period for the resource, where the resources are payable either by the first payer entity 106 (e.g., Federal Medicare system) or a second payer entity 106 (e.g., Medicare Advantage Organization (MAO)). For example, user ABC elects the resource (e.g., the hospice service), and a flag is added with the term date per pre-set rules. Since there has been a delay in communicating the active periods, such latency in communication impacts the process of determining the primacy term and primary payer entity. In one instance, the primacy term 317 has not yet been ascertained, and the analysis platform 109 generates Dec. 31, 1999, as the primacy term 317 in anticipation of delayed notifications. The analysis platform 109 also indicates the first payer entity 106 as the primary payer 319. In one instance, the primary payer 319 may change depending upon the primacy term 317.

In one example embodiment, the analysis platform 109 generates table 321 of FIG. 3C that indicates buffer application, tracking, and machine learning adjustments. Table 321 includes member name 303, payer entity ID 305, historic primacy effective 323, new primacy term 327, date notified 329, buffer effective 331, buffer term 333, and impact 335. In one instance, the historic primacy effective 323 represents past primacy terms (e.g., previous new primacy term 327). In one instance, the new primacy term 327 indicates the coordination period for the resource, where the resources are payable either by the first payer entity 106 or the second payer entity 106. In one instance, the date notified 329 indicates the date of communication between the first and second computing systems. In one instance, the buffer effective 331 represents the date the buffering period became effective. In one instance, the buffer term 333 indicates the buffering period for the resource in anticipation of the delayed notification (e.g., utilizing the 30-day average buffer). The analysis platform 109 factors the average delay in communicating data from the second computing system to the first computing system by utilizing the methods disclosed herein. The analysis platform 109 then adds a buffering period, per pre-set rules, to the timeline based on the average delay in communicating data. In one instance, the further the timeline is extended, the higher the risk. The analysis platform 109 weighs in the risk versus rewards, to reach a balanced state where the claims are not denied in error. In one instance, the impact 335 provides risk updates based on the date of notification (e.g., date notified 329).

For example, in row 337, the buffer period (e.g., buffer term 333) is determined as Dec. 31, 2022, and the date of notification (e.g., date notified 329) is Jan. 15, 2023. Since the date of notification is outside the buffer period, the impact 335 generates a notification informing the latency in communication. For example, in row 339, the buffer period is determined as Aug. 31, 2023, and the date of notification is Aug. 12, 2023. Since the date of notification is within the buffer period, the impact 335 generates a notification informing the timeliness of communication.

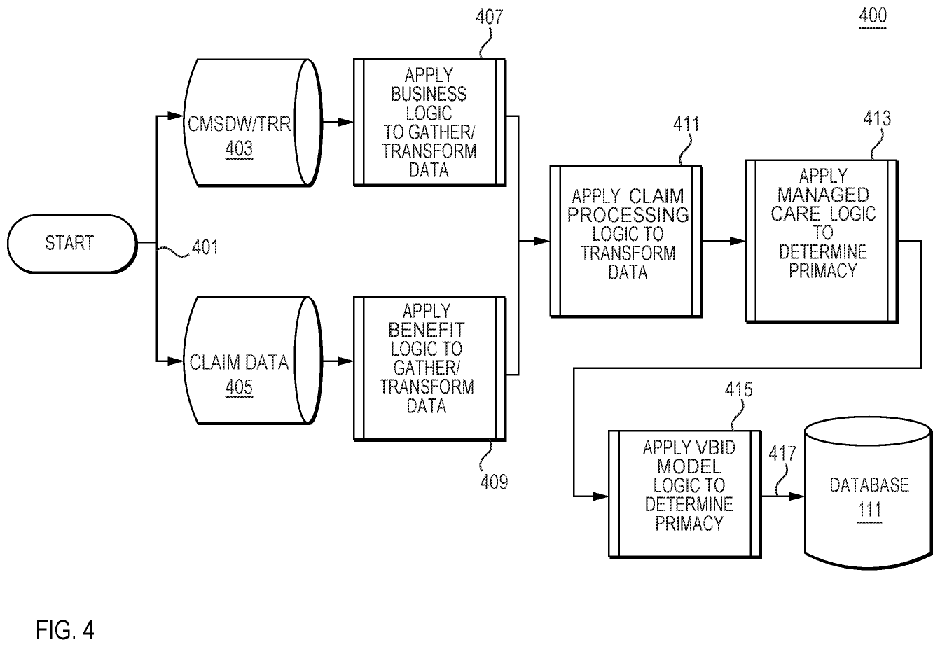

FIG. 4 is a flow diagram that illustrates a process for determining primacy between the payer entities during varying time periods of a resource, according to aspect of the disclosure. Although process 400 is illustrated and described as a sequence of steps, it is contemplated that various embodiments of the process 400 are performed in any order or combination and need not include all of the illustrated steps. Although FIG. 4 illustrates a process for developing a buffering period for a hospice service, the process 400 may be utilized to determine the buffering period for any other services.

In step 401, the analysis platform 109 accesses CMS data warehouse (CMS DW)/TRR database 403 to retrieve data (e.g., hospice data, medical service data information) associated with a user (e.g. registered patient). In one instance, the analysis platform 109 accesses CMS DW/TRR database 403 in real-time, near real-time, or per schedule (e.g., hourly, daily, weekly, bi-weekly, etc.). The analysis platform 109 also accesses other databases to retrieve claim data 405 (e.g., medical claims) associated with the user.

In step 407, the analysis platform 109 processes the retrieved data by utilizing the methods discussed herein, and applies business logic to gather or transform data. In one instance, the analysis platform 109 applies PCUG business logic in regard to the TRR transactions to identify users in-scope for a resource (e.g., hospice service or any other healthcare services).

In step 409, the analysis platform 109 processes the retrieved claim data 405 by utilizing the methods discussed herein, and applies benefit logic (e.g., Medicare benefit logic) to gather or transform data. In one instance, the analysis platform 109 utilizes historic hospice election data to calculate and apply a buffering period to the hospice primacy timelines, in anticipation of receiving new data.

In step 411, the analysis platform 109 applies claim processing logic to transform the data. For example, the hospice timeline remains ‘open-ended’ in anticipation of receiving new data during the claim processing until a true notification revokes or a true break in coverage occurs.

In step 413, the analysis platform 109 applies care logic (e.g., Medicare managed care logic) to determine primacy between one or more payer entities 106. In step 415, the analysis platform 109 applies value-based insurance design (VBID) logic to determine hospice primacy. For example, the analysis platform 109 applies the care logic and/or VBID logic to determine primacy between one or more payer entities 106 during at least one of the active period, the coordination period, or the buffering period. In one instance, the active period represents a time period when the resource is covered by the first payer sub-system. In one instance, the coordination period represents a time period when the resource is covered by the first payer sub-system or the second payer sub-system. In one instance, the buffering period represents a time period when the resource is covered by the first payer sub-system in anticipation of the enrollment notification. In step 417, the analysis platform 109 stores, in real-time or near real-time, the hospice timeline information and hospice primacy information in the database 111.

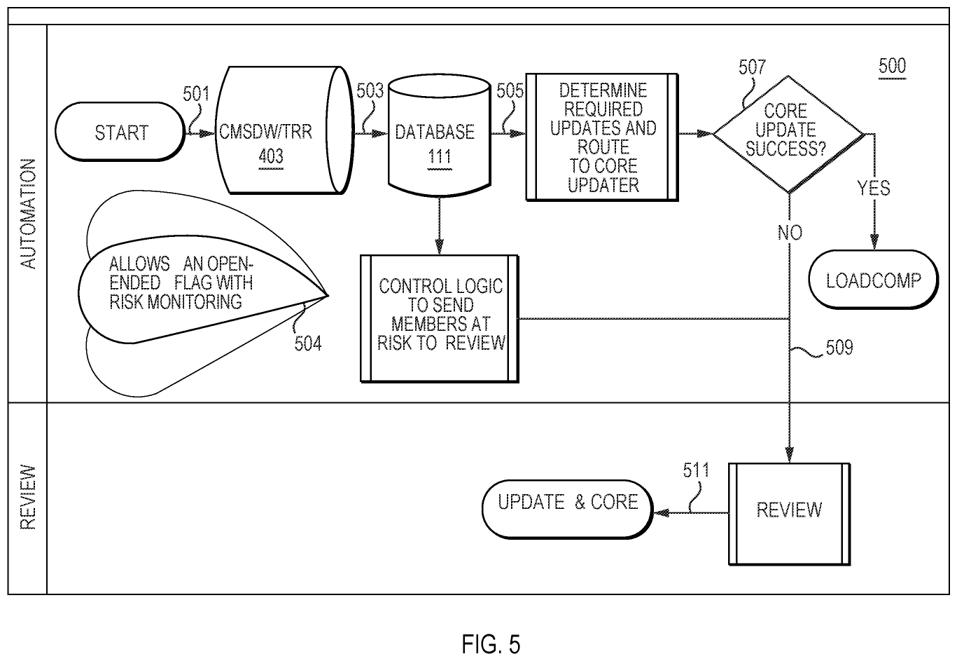

FIG. 5 is a flow diagram that illustrates a process for data updates and review while generating a buffering period, according to aspect of the disclosure. Although process 500 is illustrated and described as a sequence of steps, it is contemplated that various embodiments of the process 500 are performed in any order or combination and need not include all of the illustrated steps.

In step 501, the analysis platform 109 accesses, in real-time or near real-time, one or more storage facilitates (e.g., CMS DW/TRR database 403) to retrieve relevant information (e.g., medical service data, hospice data, etc.) associated with a user. In step 503, the analysis platform 109 stores, in real-time or near real-time, the retrieved relevant information in the database 111. In one instance, the analysis platform 109 factors the latency in communicating data (e.g., average delay) utilizing real-time and historical data and updates the hospice timeline. For example, the analysis platform 109 extends the hospice timeline by the average delays (i.e., the buffering period)). In one instance, the buffering period is an open-ended flag, and the analysis platform 109 continuously performs risk monitoring (step 504).

In step 505, the analysis platform 109 monitors, in real-time, for updates to enable automated updates of the stored data, the processed data, and the hospice timeline. The analysis platform 109 then routes the updated data to the core updater. In step 507, the analysis platform 109 determines whether the core update was successful. In one instance, upon determining the core update was successful, the analysis platform 109 loads the updated data into the system. In another instance, upon determining the core update was unsuccessful, the analysis platform 109 transmits the data associated with the users, for further review by trained professionals (step 509). Such review can also be performed by a trained machine learning model. The trained machine learning model performs training using training data (e.g., training data 912 illustrated in the training flow chart 900) that contains input and correct output, to allow the model to learn over time. The training is performed based on the deviation of a processed result from a documented result when the inputs are fed into the machine learning model, e.g., an algorithm measures its accuracy through the loss function, adjusting until the error has been sufficiently minimized. In step 511, the reviewed data updates the core system. In one instance, the analysis platform 109 accesses, in real-time, the core system to utilize the updated data for calculating the active period, the coordination period, the buffering period, or hospice timelines.

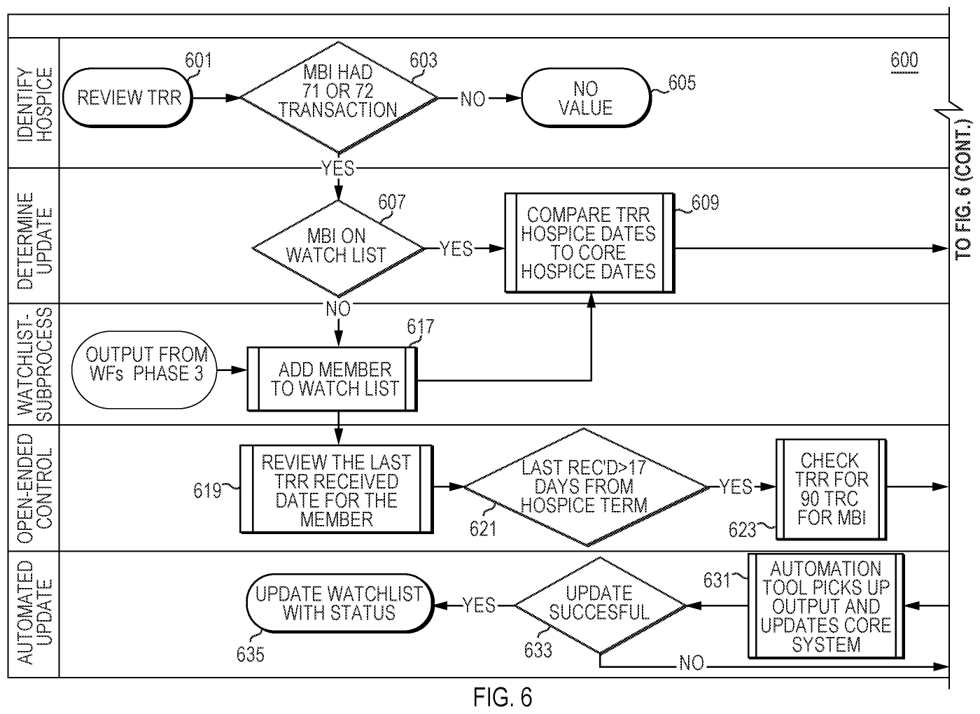

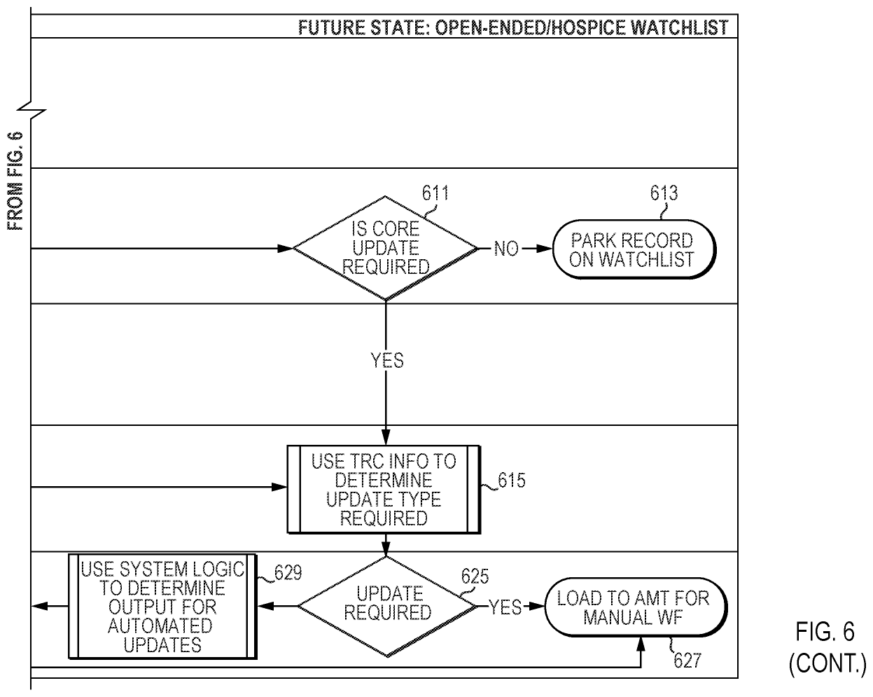

FIG. 6 is a flow diagram that illustrates a process for automated updates of the timeline for a resource, according to aspect of the disclosure. Although process 600 is illustrated and described as a sequence of steps, it is contemplated that various embodiments of the process are performed in any order or combination and need not include all of the illustrated steps. In this example embodiment, FIG. 6 illustrates a process for an automated update of the timeline for a hospice service, however, it should be understood that process 600 may be utilized for any other services.

In step 601, the analysis platform 109 accesses various databases (e.g., TRR database 403), in real-time or per schedule (e.g., hourly, daily, weekly, bi-weekly, etc.), to identify, retrieve, and review medical service information (e.g., hospice data) associated with a transaction. In one instance, the analysis platform 109 identifies members within the CMS DW who have an active Hospice timeline within the expected timeframe. In step 603, the analysis platform 109 processes the retrieved data to determine whether the Medicare beneficiary identifier (MBI) has transaction reply codes (TRC) 71 or 72 that are specific to hospice (e.g., TRC 71 and 72 indicates whether members are enrolling or dis-enrolling from hospice service). In step 605, the analysis platform 109 determines the MBI does not include hospice-specific transaction reply codes, whereupon the transaction is determined to have no value.

In step 607, the analysis platform 109 determines the MBI includes hospice-specific transaction reply codes, identifies the hospice service, and processes the transaction to determine update requirements (e.g., determining whether MBI is on the watch list). In step 609, upon determining the MBI is on the watch list, the analysis platform 109 utilizes a decision logic to compare incoming hospice dates to existing core hospice dates (e.g., hospice dates in the system). In step 611, the analysis platform 109, via a decision logic, determines whether updates are required to the core hospice dates based on the comparison. The analysis platform 109 continues to place the transaction on the watch list upon determining updates are not required to the core hospice dates (step 613). In step 615, the analysis platform 109 determines updates are required to the core hospice dates, whereupon transitions of care (TRC) data is utilized to determine updates to the core hospice dates.

In step 617, the analysis platform 109 adds hospice events and members (e.g., patients) to the hospice watch list. The updated watch list is utilized during the comparison of the TRR hospice dates to the core hospice dates at step 609.

In step 619, the analysis platform 109 reviews, in real-time or per schedule, the last TRR received date for the member. In step 621, the analysis platform 109 determines whether the last TRR received date is greater than a pre-determined time threshold (e.g., 17 days) from the hospice term. In step 623, upon determining the last TRR received date is greater than a pre-determined time threshold, the analysis platform 109 checks various databases (e.g., TRR database 403) for TRC 90 that is specific to hospice for the MBI (e.g., TRC 90 indicates death of the member). The transaction reply code 90 is then utilized to determine updates to the core hospice dates at step 615.

In step 625, the analysis platform 109 determines whether an update (e.g., manual update) is required. In step 627, upon determining an update is required, the analysis platform 109 loads the transaction to a service (e.g., AMT services) for undertaking a manual workflow (e.g., manual review). However, such review can also be performed by a trained machine learning model. On the other hand, in step 629, the analysis platform 109 utilizes a system logic to determine an output for the automated updates. In step 631, the analysis platform 109, via automation tool(s), picks up the output and updates core system. In step 633, the analysis platform 109 determines whether the update was successful. The analysis platform 109 updates the watch list with status upon determining the update was successful (step 635). On the other hand, the analysis platform 109 loads the transaction to a service (e.g., AMT) for manual review and updates upon determining the update was not successful. In one instance, the analysis platform 109 utilizes the updated data for calculating the active period, the coordination period, the buffering period, or hospice timelines.

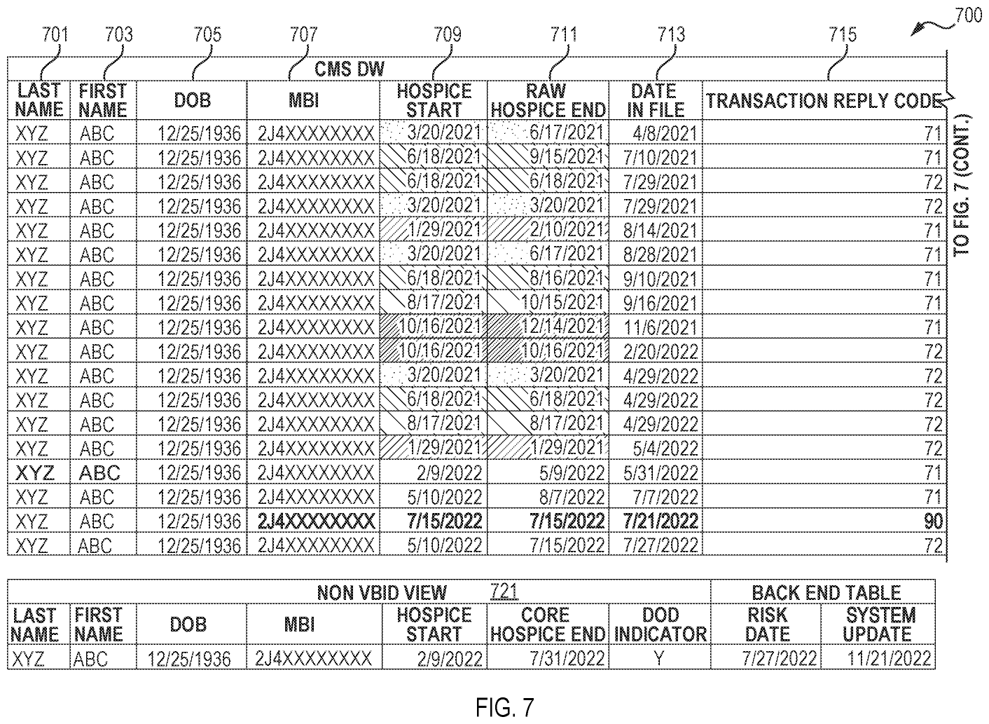

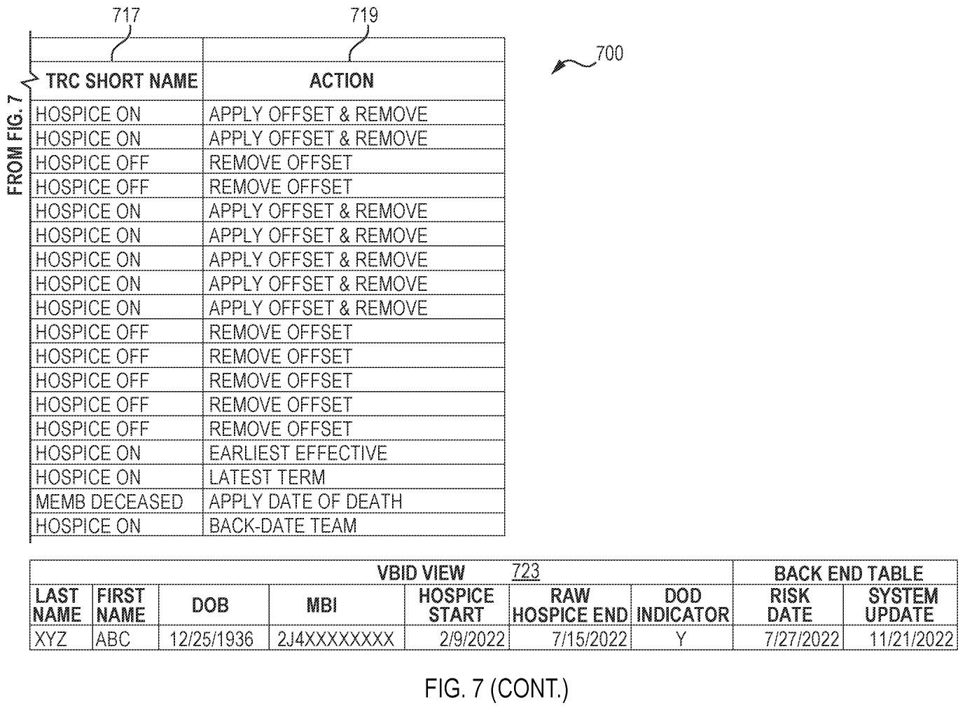

FIG. 7 is a diagram that illustrates a timeline graph for a resource, according to aspect of the disclosure. Although FIG. 7 illustrates a graph 700 related to a hospice service, it should be understood that the analysis platform 109 generates various graphs for any other types of resources.

As discussed, the analysis platform 109, via data collection module 113, collects relevant data associated with the users (e.g., patients being administered hospice). The analysis platform 109, via the data processing module 115, performs data standardization and/or data cleansing on the collected data. The analysis platform 109, via the user interface module 121, generates a presentation of the graph 700 in the user interface of the UE 101. In this example embodiment, the graph 700 includes last name 701, first name 703, date of birth (DOB) 705, Medicare beneficiary identifier (MBI) 707, hospice start date 709, hospice end date 711, date in file 713, transaction reply code (TRC) 715, TRS short name 717, and action 719. It should be understood that columns may be added or removed from the graph 700 per requirements. For example, columns may be added to the graph 700 to accommodate plan benefit package (PBP) numbers, provider numbers, or any other relevant data. In one embodiment, the analysis platform 109 processes the information in the graph 700 to determine latency in communication, and whether the users are within VBID or not.

In one instance, non-VBID table 721 and VBID table 723 indicate a break in coverage for a resource. For example, the non-VBID table 721 accounts for a break in coverage timeline (e.g., Jul. 15, 2022), and its impact on claim payment, and extends the timeline to the end of the month (e.g., Jul. 31, 2022). For example, the VBID table 723 is a consolidated table that accounts for a break in coverage by indicating the start date and end date of the resource for determining a primary payer from the one or more payer entity 106.

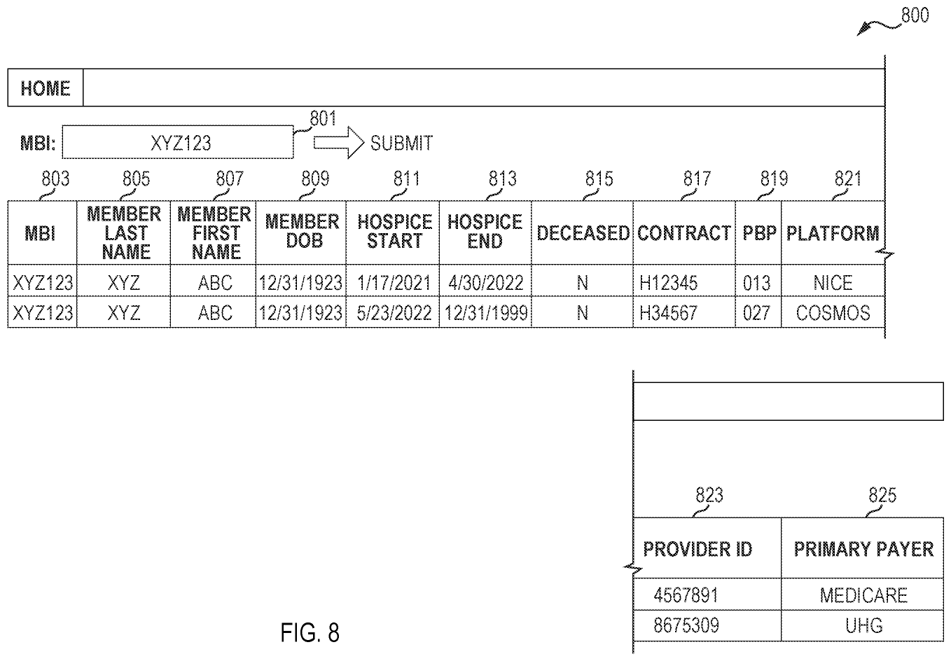

FIG. 8 is a user interface diagram that displays relevant information associated with a resource, according to aspect of the disclosure. In one instance, the analysis platform 109, via the user interface module 121, generates a presentation of the user interface 800 in the UE 101. The user interface 800 includes a data entry field 801 for entering MBI information. The user enters MBI information, whereupon the user interface 800 generates a presentation of relevant data in the UE 101. In one instance, the relevant data includes MBI 803, the last name 805, first name 807, DOB 809, hospice start date 811, hospice end date 813, deceased 815, contract 817, PBP 819, an platform 821. It should be understood that columns may be added or removed from the user interface 800 per requirements. In one instance, the analysis platform 109, via the user interface module 121, also generates a display of the provider identification 823 and the primary payer entity 825.

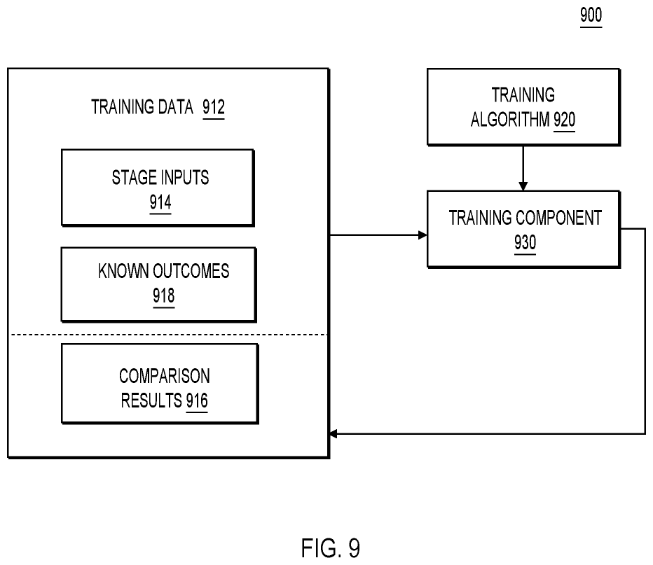

One or more implementations disclosed herein include and/or are implemented using a machine learning model. For example, one or more of the modules of the analysis platform 109 are implemented using a machine learning model and/or are used to train the machine learning model. A given machine learning model is trained using the training flow chart 900 of FIG. 9. Training data 912 includes one or more of stage inputs 914 and known outcomes 918 related to the machine learning model to be trained. Stage inputs 914 are from any applicable source including text, visual representations, data, values, comparisons, and stage outputs, e.g., one or more outputs from one or more steps from FIG. 2. The known outcomes 918 are included for the machine learning models generated based on supervised or semi-supervised training. An unsupervised machine learning model is not be trained using known outcomes 918. Known outcomes 918 includes known or desired outputs for future inputs similar to or in the same category as stage inputs 914 that do not have corresponding known outputs.

The training data 912 and a training algorithm 920, e.g., one or more of the modules implemented using the machine learning model and/or are used to train the machine learning model, is provided to a training component 930 that applies the training data 912 to the training algorithm 920 to generate the machine learning model. According to an implementation, the training component 930 is provided comparison results 916 that compare a previous output of the corresponding machine learning model to apply the previous result to re-train the machine learning model. The comparison results 916 are used by training component 930 to update the corresponding machine learning model. The training algorithm 920 utilizes machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

FIG. 10 illustrates an implementation of a computer system that executes techniques presented herein. The computer system 1000 includes a set of instructions that are executed to cause the computer system 1000 to perform any one or more of the methods or computer based functions disclosed herein. The computer system 1000 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating, ” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 1000 operates in the capacity of a server or as a client user computer in a server-client user network environment, or as a peer computer system in a peer-to-peer (or distributed) network environment. The computer system 1000 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 1000 is implemented using electronic devices that provide voice, video, or data communication. Further, while the computer system 1000 is illustrated as a single system, the term “system” shall also be taken to include any collection of systems or sub-systems that individually or jointly execute a set, or multiple sets, of instructions to perform one or more computer functions.

As illustrated in FIG. 10, the computer system 1000 includes a processor 1002, e.g., a central processing unit (CPU), a graphics processing unit (GPU), or both. The processor 1002 is a component in a variety of systems. For example, the processor 1002 is part of a standard personal computer or a workstation. The processor 1002 is one or more processors, digital signal processors, application specific integrated circuits, field programmable gate arrays, servers, networks, digital circuits, analog circuits, combinations thereof, or other now known or later developed devices for analyzing and processing data. The processor 1002 implements a software program, such as code generated manually (i.e., programmed).

The computer system 1000 includes a memory 1004 that communicates via bus 1008. Memory 1004 is a main memory, a static memory, or a dynamic memory. Memory 1004 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 1004 includes a cache or random-access memory for the processor 1002. In alternative implementations, the memory 1004 is separate from the processor 1002, such as a cache memory of a processor, the system memory, or other memory. Memory 1004 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts, or tasks illustrated in the figures or described herein are performed by processor 1002 executing the instructions stored in memory 1004. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 1000 further includes a display 1010, such as a liquid crystal display (LCD), an organic light emitting diode (OLED), a flat panel display, a solid-state display, a cathode ray tube (CRT), a projector, a printer or other now known or later developed display device for outputting determined information. The display 1010 acts as an interface for the user to see the functioning of the processor 1002, or specifically as an interface with the software stored in the memory 1004 or in the drive unit 1006.

Additionally or alternatively, the computer system 1000 includes an input/output device 1012 configured to allow a user to interact with any of the components of the computer system 1000. The input/output device 1012 is a number pad, a keyboard, a cursor control device, such as a mouse, a joystick, touch screen display, remote control, or any other device operative to interact with the computer system 1000.

The computer system 1000 also includes the drive unit 1006 implemented as a disk or optical drive. The drive unit 1006 includes a computer-readable medium 1022 in which one or more sets of instructions 1024, e.g. software, is embedded. Further, the sets of instructions 1024 embodies one or more of the methods or logic as described herein. Instructions 1024 resides completely or partially within memory 1004 and/or within processor 1002 during execution by the computer system 1000. The memory 1004 and the processor 1002 also include computer-readable media as discussed above.

In some systems, computer-readable medium 1022 includes the set of instructions 1024 or receives and executes the set of instructions 1024 responsive to a propagated signal so that a device connected to network 1030 communicates voice, video, audio, images, or any other data over network 1030. Further, the sets of instructions 1024 are transmitted or received over the network 1030 via the communication port or interface 1020, and/or using the bus 1008. The communication port or interface 1020 is a part of the processor 1002 or is a separate component. The communication port or interface 1020 is created in software or is a physical connection in hardware. The communication port or interface 1020 is configured to connect with the network 1030, external media, display 1010, or any other components in the computer system 1000, or combinations thereof. The connection with network 1030 is a physical connection, such as a wired Ethernet connection, or is established wirelessly as discussed below. Likewise, the additional connections with other components of the computer system 1000 are physical connections or are established wirelessly. Network 1030 alternatively be directly connected to the bus 1008.

While the computer-readable medium 1022 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 1022 is non-transitory, and may be tangible.

The computer-readable medium 1022 includes a solid-state memory such as a memory card or other package that houses one or more non-volatile read-only memories. The computer-readable medium 1022 is a random-access memory or other volatile re-writable memory. Additionally or alternatively, the computer-readable medium 1022 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 1000 is connected to network 1030. Network 1030 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. Network 1030 includes wide area networks (WAN), such as the Internet, local area networks (LAN), campus area networks, metropolitan area networks, a direct connection such as through a Universal Serial Bus (USB) port, or any other networks that allows for data communication. Network 1030 is configured to couple one computing device to another computing device to enable communication of data between the devices. Network 1030 is generally enabled to employ any form of machine-readable media for communicating information from one device to another. Network 1030 includes communication methods by which information travels between computing devices. Network 1030 is divided into sub-networks. The sub-networks allow access to all of the other components connected thereto or the sub-networks restrict access between the components. Network 1030 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the present disclosure, various features are sometimes grouped together in a single embodiment, figure, or description thereof for the purpose of streamlining the disclosure and aiding in the understanding of one or more of the various inventive aspects. This method of the present disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the present disclosure are practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications are made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects.

Example 1. A computer-implemented method comprising: receiving, by one or more processors of a first computing system, a first set of data; determining, by the one or more processors, a buffering period based at least in part on historical latency in communicating data between the first computing system and a second computing system; queuing, by the one or more processors, the first set of data with the buffering period for delayed processing of the first set of data; receiving, by the one or more processors and from the second computing system, a second set of data prior to expiration of the buffering period; and initiating, by the one or more processors, processing of the first set of data in view of the second set of data.

Example 2. The computer-implemented method of example 1, wherein receiving the first set of data comprises: querying, by the one or more processors, one or more databases for data associated with one or more users and historical communication data between the first computing system and the second computing system.

Example 3. The computer-implemented method of example 2, wherein the one or more databases are queried upon determining the data associated with the one or more users registered with a resource is not received from the second computing system within a pre-determined time period.

Example 4. The computer-implemented method of example 3, wherein determining the buffering period comprises: processing, by the one or more processors, the data associated with the one or more users to determine an active period for the resource and a coordination period for the resource; and processing, by the one or more processors, the historical communication data between the first computing system and the second computing system to determine the historical latency in communicating data, wherein the historical latency includes a delay in communicating a notification pertaining to the one or more users registered with the resource.

Example 5. The computer-implemented method of example 4, wherein the data associated with the one or more users includes transaction reply reports and/or claims data.

Example 6. The computer-implemented method of example 4, wherein the active period is a duration the one or more users are covered by the resource.

Example 7. The computer-implemented method of example 4, wherein the coordination period identifies primacy between a first payer sub-system and a second payer sub-system.

Example 8. The computer-implemented method of example 4, further comprising: applying, by the one or more processors, one or more rules to the data associated with the one or more users to identify at least one of the one or more users that is within coverage during the coordination period for the resource, wherein the buffering period is determined for the identified at least one user.

Example 9. The computer-implemented method of example 4, wherein the delay in communicating the notification is determined by: calculating, by the one or more processors, an average delay in transmitting the notification by the second computing system to the first computing system.

Example 10. The computer-implemented method of example 9, wherein determining the buffering period for the resource further comprises: extending, by the one or more processors, the coordination period for the resource by a time period equivalent to the average delay in transmitting the notification by the second computing system to the first computing system.

Example 11. The computer-implemented method of example 4, wherein the buffering period for the resource remains modifiable until a true notification revokes the buffering period or an occurrence of a true break in coverage by the resource.

Example 12. The computer-implemented method of example 4, further comprising: applying, by the one or more processors, one or more logics to determine primacy between one or more payer sub-systems during at least one of the active period, the coordination period, or the buffering period.

Example 13. The computer-implemented method of example 12, further comprising: causing to display, by the one or more processors, a presentation of a report in a user interface of a device, wherein the report includes at least one of the active period, the coordination period, or the buffering period.

Example 14. The computer-implemented method of example 12, wherein the active period represents a first time period the resource is covered by a first payer sub-system, wherein the coordination period represents a second time period the resource is covered by the first payer sub-system or a second payer sub-system, and wherein the buffering period represents a third time period the resource is covered by the first payer sub-system in anticipation of the notification.

Example 15. A system comprising: one or more processors of a first computing system; and at least one non-transitory computer readable medium storing instructions which, when executed by the one or more processors, cause the one or more processors to perform operations comprising: receiving a first set of data; determining a buffering period based at least in part on historical latency in communicating data between the first computing system and a second computing system; queuing the first set of data with the buffering period for delayed processing of the first set of data; receiving, from the second computing system, a second set of data prior to expiration of the buffering period; and initiating processing of the first set of data in view of the second set of data.

Example 16. The system of example 15, wherein receiving the first set of data, further comprises: querying one or more databases for data associated with one or more users and historical communication data between the first computing system and the second computing system, wherein the one or more databases are queried upon determining the data associated with the one or more users registered with a resource is not received from the second computing system within a pre-determined time period.

Example 17. The system of example 16, wherein determining the buffering period, further comprises: processing the data associated with the one or more users to determine an active period for the resource and a coordination period for the resource; and processing the historical communication data between the first computing system and the second computing system to determine the historical latency in communicating data, wherein the historical latency includes a delay in communicating a notification pertaining to the one or more users registered with the resource.

Example 18. The system of example 17, further comprising: applying one or more logics to determine primacy between one or more payer sub-systems during at least one of the active period, the coordination period, or the buffering period.

Example 19. A non-transitory computer readable medium, the non-transitory computer readable medium storing instructions which, when executed by one or more processors of a first computing system, cause the one or more processors to perform operations comprising: receiving a first set of data; determining a buffering period based at least in part on historical latency in communicating data between the first computing system and a second computing system; queuing the first set of data with the buffering period for delayed processing of the first set of data; receiving, from the second computing system, a second set of data prior to expiration of the buffering period; and initiating processing of the first set of data in view of the second set of data.

Example 20. The non-transitory computer readable medium of example 19, wherein receiving the first set of data, further comprises: querying one or more databases for data associated with one or more users and historical communication data between the first computing system and the second computing system, wherein the one or more databases are queried upon determining the data associated with the one or more users registered with a resource is not received from the second computing system within a pre-determined time period.

What is claimed is:

1. A computer-implemented method comprising:
receiving, by one or more processors of a first computing system, a first set of data;
determining, by the one or more processors, a buffering period based at least in part on historical latency in communicating data between the first computing system and a second computing system;
queuing, by the one or more processors, the first set of data with the buffering period for delayed processing of the first set of data;
receiving, by the one or more processors and from the second computing system, a second set of data prior to expiration of the buffering period; and
initiating, by the one or more processors, processing of the first set of data in view of the second set of data.

2. The computer-implemented method of claim 1, wherein receiving the first set of data comprises:
querying, by the one or more processors, one or more databases for data associated with one or more users and historical communication data between the first computing system and the second computing system.

3. The computer-implemented method of claim 2, wherein the one or more databases are queried upon determining the data associated with the one or more users registered with a resource is not received from the second computing system within a pre-determined time period.

4. The computer-implemented method of claim 3, wherein determining the buffering period comprises:
processing, by the one or more processors, the data associated with the one or more users to determine an active period for the resource and a coordination period for the resource; and
processing, by the one or more processors, the historical communication data between the first computing system and the second computing system to determine the historical latency in communicating data, wherein the historical latency includes a delay in communicating a notification pertaining to the one or more users registered with the resource.

5. The computer-implemented method of claim 4, wherein the data associated with the one or more users includes transaction reply reports and/or claims data.

6. The computer-implemented method of claim 4, wherein the active period is a duration the one or more users are covered by the resource.

7. The computer-implemented method of claim 4, wherein the coordination period identifies primacy between a first payer sub-system and a second payer sub-system.

8. The computer-implemented method of claim 4, further comprising:
applying, by the one or more processors, one or more rules to the data associated with the one or more users to identify at least one of the one or more users that is within coverage during the coordination period for the resource, wherein the buffering period is determined for the identified at least one user.

9. The computer-implemented method of claim 4, wherein the delay in communicating the notification is determined by:
calculating, by the one or more processors, an average delay in transmitting the notification by the second computing system to the first computing system.

10. The computer-implemented method of claim 9, wherein determining the buffering period for the resource further comprises:
extending, by the one or more processors, the coordination period for the resource by a time period equivalent to the average delay in transmitting the notification by the second computing system to the first computing system.

11. The computer-implemented method of claim 4, wherein the buffering period for the resource remains modifiable until a true notification revokes the buffering period or an occurrence of a true break in coverage by the resource.

12. The computer-implemented method of claim 4, further comprising:
applying, by the one or more processors, one or more logics to determine primacy between one or more payer sub-systems during at least one of the active period, the coordination period, or the buffering period.

13. The computer-implemented method of claim 12, further comprising:
causing to display, by the one or more processors, a presentation of a report in a user interface of a device, wherein the report includes at least one of the active period, the coordination period, or the buffering period.

14. The computer-implemented method of claim 12, wherein the active period represents a first time period the resource is covered by a first payer sub-system, wherein the coordination period represents a second time period the resource is covered by the first payer sub-system or a second payer sub-system, and wherein the buffering period represents a third time period the resource is covered by the first payer sub-system in anticipation of the notification.

15. A system comprising:
one or more processors of a first computing system; and
at least one non-transitory computer readable medium storing instructions which, when executed by the one or more processors, cause the one or more processors to perform operations comprising:
receiving a first set of data;
determining a buffering period based at least in part on historical latency in communicating data between the first computing system and a second computing system;
queuing the first set of data with the buffering period for delayed processing of the first set of data;
receiving, from the second computing system, a second set of data prior to expiration of the buffering period; and
initiating processing of the first set of data in view of the second set of data.

16. The system of claim 15, wherein receiving the first set of data, further comprises:
querying one or more databases for data associated with one or more users and historical communication data between the first computing system and the second computing system,
wherein the one or more databases are queried upon determining the data associated with the one or more users registered with a resource is not received from the second computing system within a pre-determined time period.

17. The system of claim 16, wherein determining the buffering period, further comprises:
processing the data associated with the one or more users to determine an active period for the resource and a coordination period for the resource; and
processing the historical communication data between the first computing system and the second computing system to determine the historical latency in communicating data, wherein the historical latency includes a delay in communicating a notification pertaining to the one or more users registered with the resource.

18. The system of claim 17, further comprising:
applying one or more logics to determine primacy between one or more payer sub-systems during at least one of the active period, the coordination period, or the buffering period.

19. A non-transitory computer readable medium, the non-transitory computer readable medium storing instructions which, when executed by one or more processors of a first computing system, cause the one or more processors to perform operations comprising:
receiving a first set of data;
determining a buffering period based at least in part on historical latency in communicating data between the first computing system and a second computing system;
queuing the first set of data with the buffering period for delayed processing of the first set of data;
receiving, from the second computing system, a second set of data prior to expiration of the buffering period; and
initiating processing of the first set of data in view of the second set of data.

20. The non-transitory computer readable medium of claim 19, wherein receiving the first set of data, further comprises:
querying one or more databases for data associated with one or more users and historical communication data between the first computing system and the second computing system,
wherein the one or more databases are queried upon determining the data associated with the one or more users registered with a resource is not received from the second computing system within a pre-determined time period.
